(19) United States
(12) Patent Application Publication
(10) Pub. No.: US 2017/0236116 A1
(43) Pub. Date: Aug. 17, 2017

(54) APPARATUS, SYSTEM AND METHOD FOR CREATING A RESTRICTED USE PAYMENT CARD

(71) Applicant: Emo Oil Ltd, Co. Laois (IE)

(72) Inventors: Benjamin Marcus JORDAN, Leeds (GB); Niklas Olov STENSON, Aby (SE)

(73) Assignee: Emo Oil Ltd, Co. Laois (IE)

(21) Appl. No.: 15/501,911

(22) PCT Filed: Oct. 6, 2015
(86) PCT No.: PCT/EP2015/073066

§ 371 Date: Feb. 6, 2017

(30) Foreign Application Priority Data
Oct. 6, 2014 (GB) 1417624.2
Jan. 6, 2015 (GB) 1500128.2

(51) Int. Cl. G06Q 20/34

(52) U.S. Cl. CPC G06Q 20/341

(57) ABSTRACT

A system for creating a restricted use payment card comprising a data processing environment non-compliant with a security requirement for payment cards and a data processing environment compliant with a security requirement for payment cards is disclosed. The non-compliant data processing environment is configured to generate a label, store the label in the non-compliant data processing environment, and provide to the compliant data processing environment a request to create a new payment card. The compliant data processing environment is configured to generate new payment card data, generate a token from the new payment card data; and provide the token to the non-compliant data processing environment. The non-compliant data processing environment is further configured to replace the stored label with the token value.

### FIELD

The present invention relates to an apparatus, system and method for creating a restricted use payment card. In particular, but not exclusively, the present invention relates to tokenisation of payment card data and a system and method for generating and storing tokens together with associated restricted use parameters.

### BACKGROUND

Payment systems for goods and services using a payment card such as a credit account card or debit card for a bank account are ubiquitous. Such payment cards are typically provided in Europe by three main operators: EuroPay; MasterCard; and Visa; hereinafter designated EMV. Additionally, other cards, herein referred to as “purchase cards”, are provided which effectively charge a purchase to an account without any transfer of value at the point of obtaining the good or service, with settlement of the account occurring at a later date. Such purchase cards may be considered to be a form of account card which sets purchases against a particular account rather than making payment for a purchase. A particular example of such account cards are “fuel cards” used for the purchase of fuel by drivers of vehicles operating within a vehicle fleet, for example, and wherein settlement of the fuel purchases is performed by the owner of the fleet at some convenient time, for example at monthly intervals. The operator of the fuel card account system invoices its customers, typically the owner of the fleet, at appropriate time intervals.

Use of an EMV payment card invokes a transfer of value at the time of purchase and consequently in many jurisdictions a receipt is necessary for the purchase, in particular because it, or issue of one that, contains sufficient details of the good or service purchased and the value of the purchase to check that sales tax applied to the purchase is appropriate. Conventionally, receipts are provided in paper form and it is necessary to ensure that sufficient paper is available at a payment terminal for a receipt to be issued. This is inconvenient and time-consuming for manned payment terminals. However, if a payment terminal is unmanned and particularly if it is in a remote location maintaining sufficient paper in the payment terminal to provide receipts is a significant overhead and worse still if insufficient paper is provided purchases may not be made and goods and services not dispensed depending upon local laws and regulation.

Many challenges exist in handling sensitive data, such as EMV payment card numbers, bank account numbers and the like. Typically, in use, a system for processing such sensitive data will transmit the sensitive data between multiple authorised entities, any of which can store the sensitive data. Sensitive data is vulnerable in such an environment to interception by unauthorised entities at multiple points, such as during transmission between authorised entities or while stored at an authorised entity.

To prevent unauthorised access to sensitive data, steps can be taken to protect the sensitive data. Such data protection measures are required by many jurisdictions for various categories of sensitive data. The sensitive data can be encrypted during transmission or storage using an encryption algorithm and encryption key. However, encryption can be overcome/broken using a variety of hacking methods, and the use of encryption in financial systems is often subject to resource intensive audit requirements. Data storage security measures can be implemented while the sensitive data is stored at an authorised entity, but such storage security measures generally protect against intrusion and do not protect the sensitive data after an unauthorised entity has overridden or bypassed the storage security measures. In addition, sensitive data becomes vulnerable to interception in the event that an associated payment card is lost or stolen.

Aspects and embodiments in accordance with the present invention were devised with the foregoing in mind.

### SUMMARY

Viewed from a first aspect, there is provided a method for creating a restricted use payment card, the method comprising:
generating, in a data processing environment non-compliant with a security requirement for payment cards, a label;
   storing the label in the non-compliant data processing environment; and
   providing to a data processing environment compliant with the security requirement a request to create a new payment card;
   generating in the compliant data processing environment:
      new payment card data; and
      a token from the new payment card data;
   providing the token to the non-compliant data processing environment; and
   replacing the stored label with the token value.
      Viewed from a second aspect there is provided a method for creating a restricted use payment card, the method comprising:
generating in a first data processing environment compliant with a security requirement for payment cards a token from a payment card data;
associating with the token a restriction specification defining a use restriction for the payment card; and
storing the token and restriction specification.

Viewed from a third aspect there is provided a system for creating a restricted use payment card comprising a data processing environment non-compliant with a security requirement for payment cards and a data processing environments compliant with a security requirement for payment cards;
the non-compliant data processing environment configured to:
   generate a label;
   store the label in the non-compliant data processing environment; and
   provide to the compliant data processing environment a request to create a new payment card;
the compliant data processing environment configured to:
   generate new payment card data;
   generate a token from the new payment card data; and
   provide the token to the non-compliant data processing environment;
the non-compliant data processing environment further configured to replace the stored label with the token value.

Viewed from a fourth aspect there is provided apparatus for creating a restricted use payment card, configured to:
comply with a security requirement for payment cards;
generate a token from a payment card data;
associate with the token a restriction specification defining a use restriction for
the payment card; and store the token and restriction specification.

One or more embodiments in accordance with one or more of the first to fourth aspects may provide an arrangement and provide for a process which may minimise or at least reduce unauthorised use of cardholder data and reduce cross channel fraud for card-not-present transactions, as well as in transaction environments that combine elements of card-present and card-not-present transactions. Additionally, an embodiment in accordance with one or more of the first to fourth aspects provide an arrangement in which restrictions on the use of a payment card may be configured in a non-PCI DSS compliant data processing environment, for example an environment which would allow an individual customer access to the relevant records to adjust the restrictions for themselves.

In one embodiment, the label may be provided to the compliant data processing environment with the request to create a new payment card thereby providing a record of the request for a new restricted use payment card or for restrictions to be applied against an existing payment card. Additionally, providing the label with a request for the label to be included in the response from the compliant data processing environment comprising the token so that the token may be appropriately matched to the record stored in the non-compliant data processing environment to which the token is to be applied.

Typically, a restriction specification defining a use restriction for the new payment card is stored in association with the label such that when the label is replaced with the token the restriction specification is automatically applied to the token.

Suitably, the label is stored in association with a customer identifier to provide easy identification of a customer and associated label and of course token when the label is replaced by the token.

In a particularly flexible embodiment there is provided an interface to the non-compliant data processing environment configured to permit creation of the restriction specification. Such an interface may be utilised by a purchase card system operator to configure restriction specification is but also may be accessible to a customer or the card user to develop their own restriction specification.

Typically, the restriction specification and token are stored in respective fields of a customer restricted use card record which is a suitable way of storing information. In one or more particular embodiments the customer restricted use card record provides sub-fields for the restriction specification for storing a respective type of restriction.

Suitably, the label comprises a temporary card number which provides for easy replacement by or substitution with a token on or having a similar format to primary account number of a payment card.

One or more embodiments in accordance with the second and fourth aspects may provide the token and restriction specification to a second data processing environment non-compliant with the security requirement for payment cards. Thus, manipulation and management of sensitive card data may take place in a PCI DSS compliant data processing environment while restriction specification can be configured and maintained in a non-PCI DSS compliant data processing environment.

Viewed from a fifth aspect there is provided a method for applying a use restriction to a payment card, the method comprising:
at a terminal compliant with a security requirement for payment cards generating a token from a payment card data input to the terminal and transmitting the token to a data processing environment non-compliant with a security requirement for payment cards;
at the non-compliant data processing environment:
   receiving the token identifying one or more use restrictions associated with the token;
   providing a response to the terminal comprising the one or more use restrictions associated with the token;
at the terminal:
   receiving the one or more use restrictions associated with the token;
   determining whether a purchase submitted to the terminal satisfies the one or more use restrictions; and
initiating fulfilment of the purchase submitted to the terminal satisfying the one or more use restrictions.

Viewed from a sixth aspect there is provided a system for applying a use restriction to a payment card, comprising a terminal compliant with a security requirement for payment cards and a data processing environment non-compliant with a security requirement for payment cards;
the terminal configured to:
   generate a token from a payment card data input to the terminal; and
   transmit the token to the non-compliant data processing environment;
the non-compliant data processing environment configured to:
   receive the token identifying one or more use restrictions associated with the token;
   provide a response to the terminal comprising the one or more use restrictions associated with the token;
the terminal further configured to:
   receive the one or more use restrictions associated with the token;
   determine whether a purchase submitted to the terminal satisfies the one or more use restrictions; and
   initiate fulfilment of the purchase submitted to the terminal satisfying the one or more use restrictions.
One or more embodiments in accordance with the fifth or sixth aspect provide an environment in which the use of a payment card may be constrained in accordance with restriction specifications set up for that card without the need for specific card data to be interrogated or utilised. Generally, the terminal is a payment card terminal.

Typically, initiating fulfilment of the purchase comprises transmitting transaction details for the purchase to a merchant acquirer for the payment card.

Optionally or additionally, a one of the one or more use restrictions may comprise a discount value for applying to a transaction, the discount being applied to the value of the purchase prior to initiating fulfilment of the purchase. Optionally, the discount may be applied to the value during fulfilment of the purchase.

In accordance with an arrangement for protecting and restricting use of a card, one or more embodiments in accordance with the fifth and sixth aspects may inhibit a transaction with the payment card for a purchase submitted to the compliant card payment terminal not satisfying the one or more use restrictions.

Typically, one or more embodiments are configured to initiate fulfilment of the purchase by transmitting transaction details for the purchase to a merchant acquirer for the payment card.

### LIST OF FIGURES

A detailed description of one or more embodiments in accordance with the invention will now be described, by way of non-limiting example only, and with reference to the accompanying drawings, in which:

FIG. 1 is a schematic illustration of an overview of a conventional payment card system;

FIG. 2 is a schematic illustration of an overview of a system in accordance with an embodiment of the invention;

FIG. 3 is a process flow control diagram of the overall operation of an embodiment in accordance with the invention;

FIG. 4 is a schematic illustration of a payment terminal comprising apparatus in accordance with an embodiment of the invention;

FIG. 5 is a process flow control diagram for a card reader sub-module in accordance with an embodiment of the invention;

FIG. 6 is a process flow control diagram for a registration sub-module in accordance with an embodiment of the invention;

FIG. 7 is a schematic illustration of a table structure in a relational database in accordance with an embodiment of the invention;

FIG. 8 is a process flow control diagram or an embodiment in accordance with the invention for creating a restricted use card;

FIG. 9 is a process flow control diagram for an embodiment in accordance with the invention for using a restricted use card;

FIG. 10 is a process flow control diagram for a registration sub-module in accordance with an embodiment the invention for supporting registration of a further card for an existing user;

FIG. 11 is a diagrammatic representation of the restriction parameters that may be applied to a token for a payment card for an embodiment in accordance with the invention.

### DESCRIPTION

Payment cards and payment card systems are well-known and indeed ubiquitous in the developed economies. Given that the systems process bank and credit card details the systems and apparatus need to be secure and payment card operators such as EuroPay, Mastercard and Visa (EMV) follow the Payment Card Industry Data Security Standard (PCI DSS) guidelines to implement security measures to reduce the loss or theft of sensitive cardholder data amongst other things. The PCI DSS guideline security measures for payment card terminals and systems include encryption of card holder data for transmission across open, public networks and in particular the Primary Account Number (PAN) is required to be stored in unreadable form utilising encryption, one-way hashing and tokenisation techniques, (see PCI DSS requirement 3.4).

In light of the PCI DSS security measures, systems and apparatus for processing and storing card holder data can be expensive to implement and maintain.

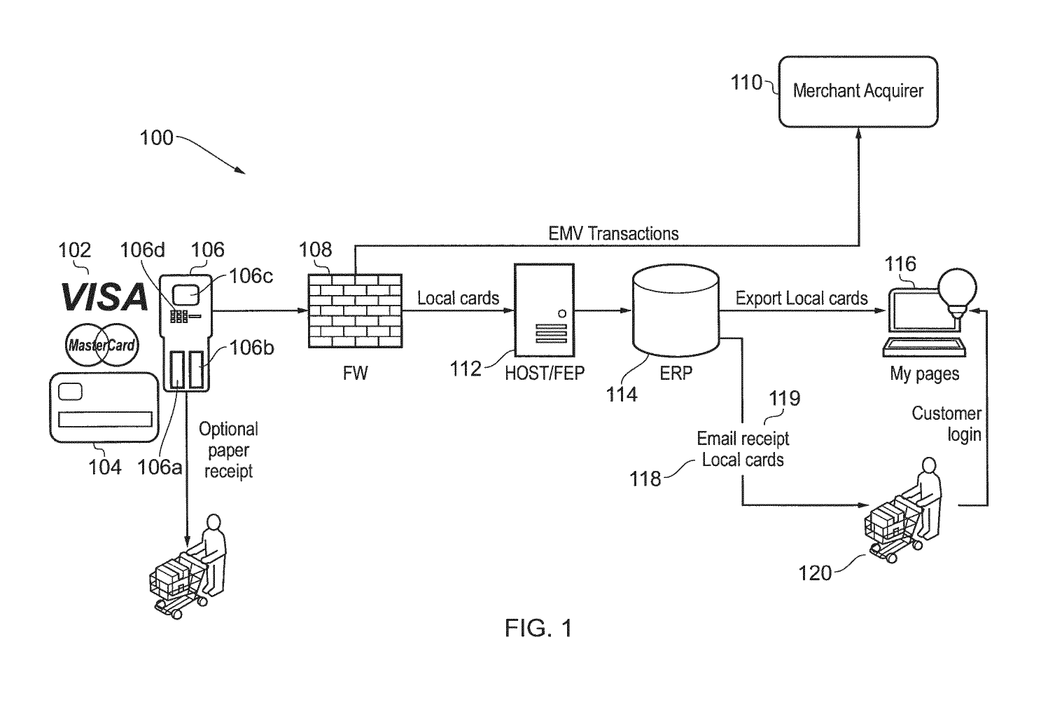

Referring now to FIG. 1, an example of a conventional card payment system 100 is schematically illustrated which is operative for EMV payment cards 102 and also purchase cards 104. A payment terminal 106 includes a card payment module 106a, a Point of Sale (POS) module 106b, a display screen 106c and a keypad 106d. The payment terminal may be an outside payment terminal (OPT) so that a user may pay for fuel by card at, for example, an unmanned fuel dispensing apparatus. Optionally, the payment terminal 106 may be inside such as in a kiosk or shop (an inside payment terminal IPT).

The payment terminal 106 is networked to a communications network which may be a private network but typically would also include open, public telecommunications networks for long distance communications, in particular if communicating data using the Internet. The network communication is through a firewall 108 which assists in protecting the payment terminal 106 and any local network of which it may form a part from malevolent communications and attacks from outside the payment terminal 106 or local network.

The system 100 includes an EMV Merchant Acquirer 110 which is a financial services institution such as a bank and receives payment card cardholder details to effect payment. In the described system there is also a server system 112 comprising an application server for a purchase card scheme and to which purchase card details are provided so that an invoice may be generated at the OPT or the value entered into an account for that purchase card. The server system 112 also includes electronic storage systems. Server system 112 may host a purchase card scheme data processing application 114 which amongst other things may transmit transaction details to a transactions webserver 116 which may be accessed by purchase card users 120 or account managers to monitor purchases. The purchase card scheme data processing application 114 may also provide electronic receipts 118 which are emailed to purchase card users 120. The purchase details transmitted to the transactions webserver 116 may be in the form of electronic receipts. A user/customer may access a webpage ‘my pages’ 116 to view their receipts and also account information.

Optionally or additionally the transaction web server 116 may provide the electronic receipt to the user/customer by email. The purchase card scheme data processing application 114 may also manage a database implemented on the electronic storage systems. The purchase card scheme data processing application may include, comprise or be functionally operable with an Enterprise Resource Planning (ERP) application. The ERP application is business management software—usually a suite of integrated applications—that an enterprise can use to collect, store, manage and interpret data from many sources such as other enterprises and users such as customers.

The operator of the purchase card scheme can maintain a record of transactions made by respective cards in the scheme and store payment details in a manner that need not be PCI DSS compliant because such purchase card schemes do not authorise a transfer of actual value and do not fall under the PCI DSS guidelines. For example, cardholder details need not be encrypted and the storage system need not be as secure as required by the PCI DSS guidelines. As non-PCI DSS compliant systems are less complex to build and maintain they are cheaper to implement.

However, the operator of the card scheme does not retain information concerning the purchase in which the EMV card was used. Consequently, benefits that may be offered to users of the purchase card scheme, such as discounts for volume purchases and other inducements to use the purchase card or purchase particular goods or services, cannot be provided to EMV card users based on transactions using their EMV card and using the card scheme operator's systems 112/114. If such information were to be used by the card scheme operator their systems 112/114 would have to be PCI DSS compliant with all the attendant costs of setting up and maintaining such PCI DSS compliant systems.

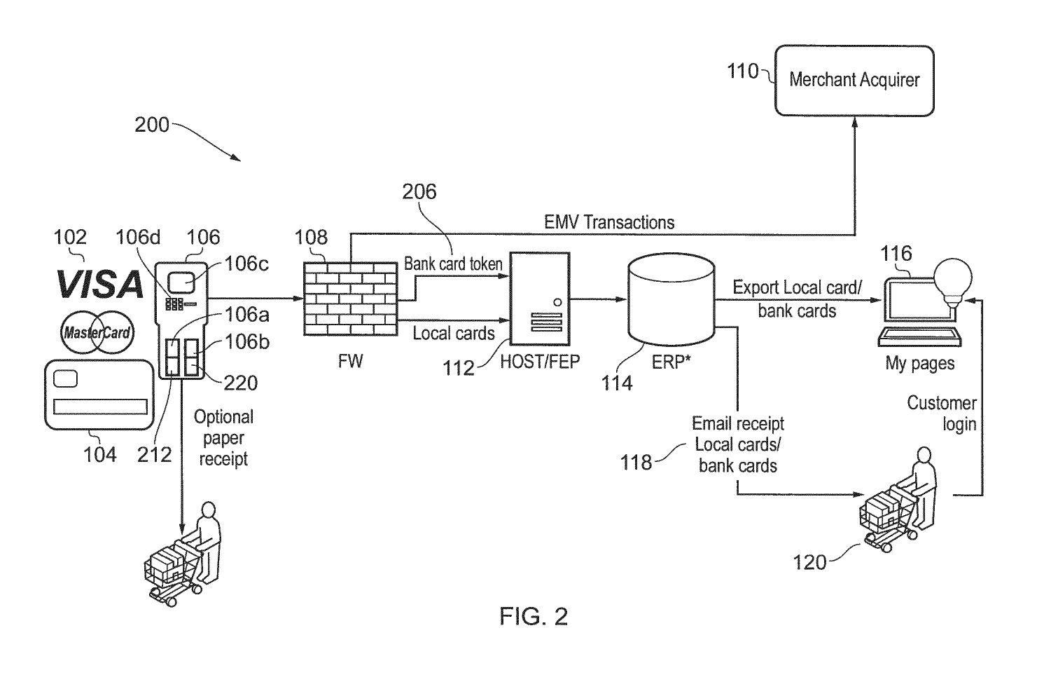

A system 200 implementing an embodiment in accordance with the invention is schematically illustrated in FIG. 2. Like numerals designate like parts illustrated in FIG. 1 as the context requires. The system 200 may provide for purchases using EMV cards 102 or purchase cards 104 through a payment terminal 106. The card payment module 106a includes a tokenisation sub-module 212 which comprises programmatic instructions executable to tokenise one or more elements of EMV cardholder data. The POS module 106b includes a registration sub-module 220 which comprises programmatic instructions executable for registering an EMV cardholder into a scheme which may provide purchase details, such as receipts, electronically and/or benefits such as a loyalty scheme.

The system 200 also includes a firewall 108 through which communication is made to EMV Merchant Acquirer 110 and server system 112 hosting the purchase card data processing application 114. The payment terminal 106 not only transmits EMV cardholder data or purchase cardholder data to the EMV Merchant Acquirer 110 and server system 112 respectively but also transmits a token 206 derived from one or more elements of the EMV cardholder details. EMV token 206 is generated in such a way that it is decoupled from the cardholder data from which it is derived, i.e. the cardholder data is not evident from the token 206, and is therefore not required to be handled in a PCI DSS compliant manner.

EMV token 206 may be stored in the server system 112/114 with EMV cardholder data (excluding the full card account number) and processed without PCI DSS compliant procedures.

The purchase card scheme data processing application 114 provides electronic transaction details to webserver 116 and/or electronic receipts 118 which are emailed to purchase card users 120 as in system 100. However, in the described embodiment EMV receipts 119 may also be provided to users 120 who paid with an EMV card by linking the token 206 with acquired cardholder details and the transaction that took place with the tokenisation. As illustrated in FIGS. 1 and 2, purchase cards transactions are referenced as “local cards”.

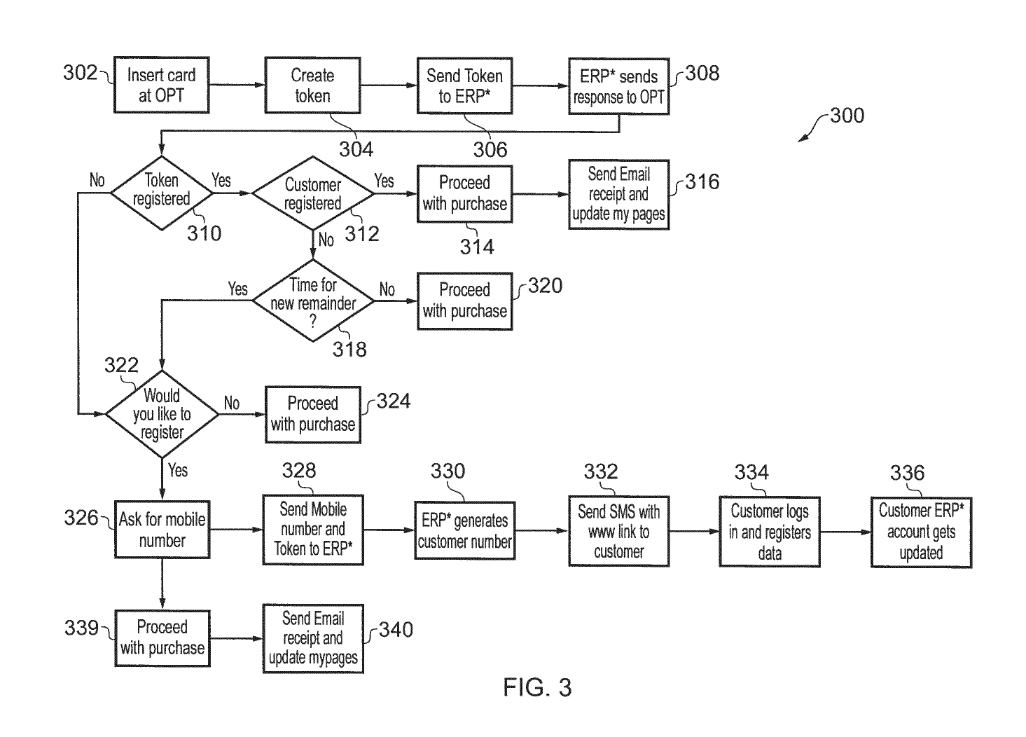

A general overview of a registration procedure 300 in accordance with an embodiment of the invention will now be described with reference to the process flow control diagram of FIG. 3.

A customer 120 inserts an EMV payment card at a payment terminal 106, step 302, and a token 206 based on the EMV payment card details is created, step 304. The token 206 is transmitted to the purchase card scheme data processing application 114 on server system 112, step 306, which responds to acknowledge the transmission of the token 206, step 308. In the described embodiment, the purchase card scheme data processing application comprises an enterprise resource planning (ERP) management software capable of processing, storing and managing data received from payment terminals 106 located at multiple businesses.

The purchase card scheme data processing application 114 then checks in the database to determine if the token 206 has already been registered, i.e. the customer is already a user, step 310, and if so sends a message to the payment terminal 106 to proceed with the purchase, step 314. The purchase card scheme data processing application 114 also tests the database to determine whether a customer 120 has registered against the token 206, step 312, and if a customer 120 has registered against the token 206 sends an email receipt to the customer 120 and updates transactions webserver 116 with details of the transaction, step 316. If no customer has registered against the token 206 then the purchase card scheme data processing application 114 determines whether a reminder is due to be issued to register a customer against the token, step 318, for example by inspecting a record of when the customer last made a purchase with the card or a reminder to register was last sent and if the elapsed time since one and/or other of those events exceeds a threshold value, issuing a reminder. If no reminder is due then the payment terminal proceeds with the purchase without further action concerning registration and no further action is taken with regard to transmission of receipts, step 320. If the purchase card scheme application determines that a reminder is to be issued, the application sends a message to the payment terminal 106 to displays an invitation to the user to register to register in the system, step 322. Payment terminal 106 then proceeds with the purchase.

If at step 310 it is determined that the token 206 has not yet been registered then a message is transmitted to the payment terminal to initiate a question being presented to the user interface asking if the customer 120 would like to register the token 206, step 322, i.e. become a user. If the customer response indicates “No” then the payment terminal proceeds with the purchase without further action concerning registration, step 324. However, if the customer 120 inputs a response indicating “Yes” then a request is made for the customer's 120 mobile telephone number, step 226. Following input of the mobile telephone number the mobile number and the token 206 are transmitted to the purchase card scheme data processing application 114 at step 328.

The purchase card scheme data processing application 114 generates a customer user identity (user ID) in response to receiving the mobile number and token 206, step 330 and sends a Short Message Service (SMS) message comprising a URL link to the purchase card scheme data processing application 114 to the customer 120, step 332.

Responsive to receiving the SMS message with the URL link, the customer 120 may use the link to login to the purchase card scheme data processing application 114 and register their personal data, step 334. The customer 120 may also configure the purchase card scheme data processing application 114 to specify purchase restrictions and security parameters to be associated with the token 206 as will be described below. The purchase card scheme data processing application 114 account for that customer 120 is updated with the personal data and token 206, step 336. Additionally, the payment terminal 106 proceeds with the purchase, step 339. As the customer 120 has initiated registration by having the token 206 created and sent to the purchase card scheme data processing application 114 transaction data can be stored against the token 206 so that when the customer 120 competes their registration against the token 206 an email receipt may be sent to the customer 120 and transactions webserver 116 updated with details of the transaction, step 340.

Thus, the purchase card scheme data processing application 114 includes token 206 stored in association with customer personal data. Consequently, transactions utilising the EMV payment card to which the token 206 corresponds may be logged against the customer personal data. This facilitates payment receipts and account information relating to such purchases for the customer. Additionally, a purchase card scheme such as a loyalty scheme may give benefits to a customer dependent upon the transactions made with the EMV payment card associated with the token 206 such as discounts or other loyalty benefits.

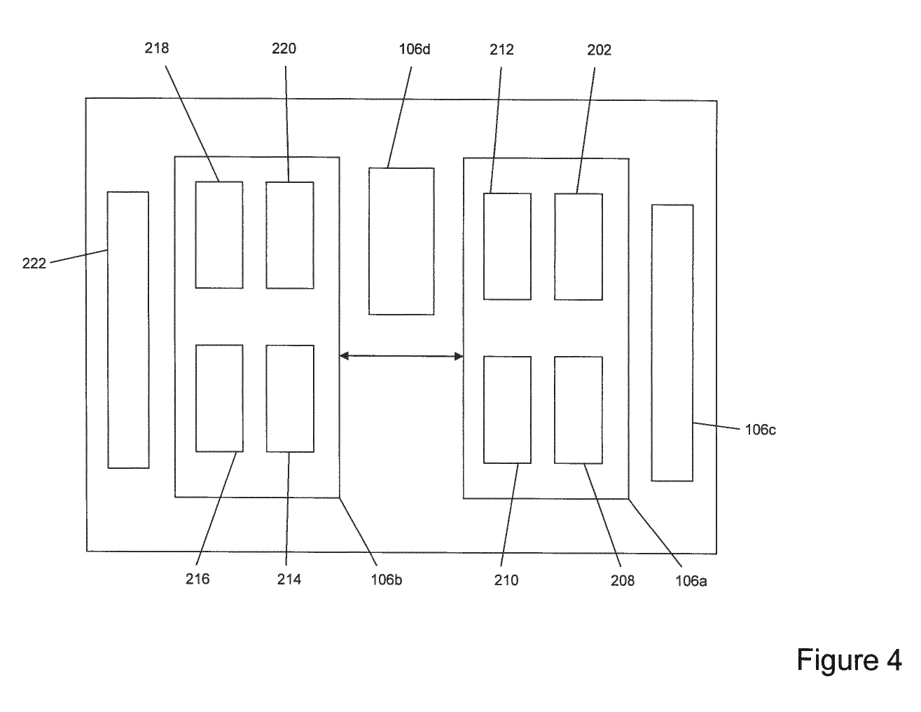

A payment terminal 106 in accordance with an embodiment of the invention will now be described with reference to FIG. 4. Payment terminal 106 includes a card reader module 106a, a registration module 106b and a display 106c. A payment terminal 106 also includes a network interface 222 for communicating with a communications network such as a private network or public telecommunications network.

Card reader module 106a includes a card reader 202 under the control of a controller 208. Typically, controller 208 comprises a microcontroller or microprocessor operative to execute programmatic instructions supplied to it. The card reader module 106a also includes a display driver 210 for supplying display signals to display 106c under the control of controller 208 during operation of the card reader 202 and other aspects of the card reader module 106a.

Card reader module 106a also includes a tokenisation sub-module 212.

In operation, an EMV payment card 102 is input into the card reader 202 and the cardholder account details read from the card under the control of controller 208. Card reader module 106a is therefore PCI DSS compliant because cardholder account details are processed within the module. Such a card reader module 106a may be referred to as a High Security Module (HSM) in PCI DSS terminology. Cardholder account details are encrypted, in particular for transmission from the card reader module 106a across an open network, within the card reader module 106a. Encryption, and possibly tokenisation, utilises cryptographic keys which are kept securely within the card reader module 106a. Cryptographic keys are supplied by the organisations who wish to encrypt the data, for example the financial institution, EMV Merchant Acquirer 110, operating a particular payment card 102. A token may be reversible or non-reversible, i.e. there is or there is not a way back to the details from which it was derived. Although for a practical matter EMV card readers may use cryptographic techniques to tokenise card details it is the case that card details may be tokenised without using cryptographic techniques. A discussion of encryption and tokenisation may be found at the following URL:

https://townsendsecurity.com/sites/default/files/Encryption vs Tokenization.pdf

In the described embodiment, the purchase card scheme operator supplies a key, cryptographic or otherwise or other algorithmic parameter, for use in tokenisation sub-module 212 for generating the payment card details token 206. The cryptographic key supplied by the purchase card scheme operator must be PCI DSS compliant but may be relatively easily obtainable through an existing financial services institution or EMV payment card operator already PCI DSS compliant. The tokenisation algorithm is “one way” because it is not necessary within the purchase card operator's system to be able to decrypt or reverse the token to generate the payment card details. Indeed, it is highly undesirable in the purchase card scheme system to be able to decrypt or reverse the token to generate the payment card details.

The POS module 106b includes a controller 214, a display driver 216, a POS operations sub-module 218 and a registration sub-module 220. The POS module 106b is also connected to the network interface 222. The POS operations sub-module 218 provides programmatic instructions to controller 214 to implement a point-of-sale module, including amongst other things instructing display driver 216 to display information concerning a purchase such as quantity, volume and/or total cost, for example.

The registration sub-module 220 comprises programmatic instructions executable by controller 214 to implement the token registration process described in general outline above with reference to FIG. 3.

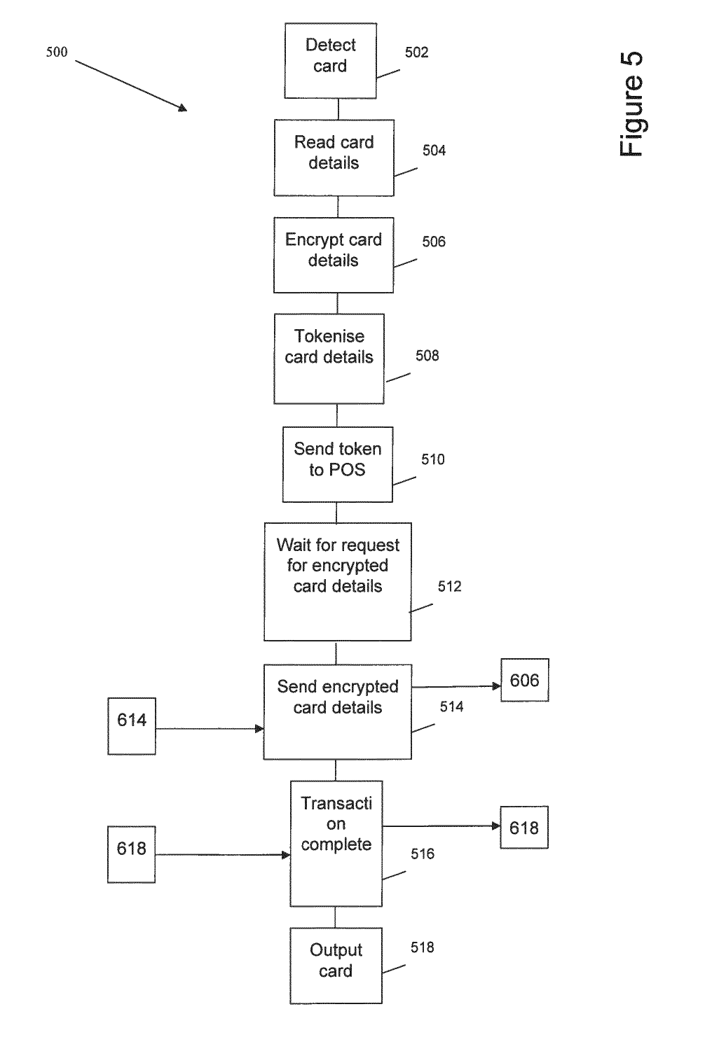

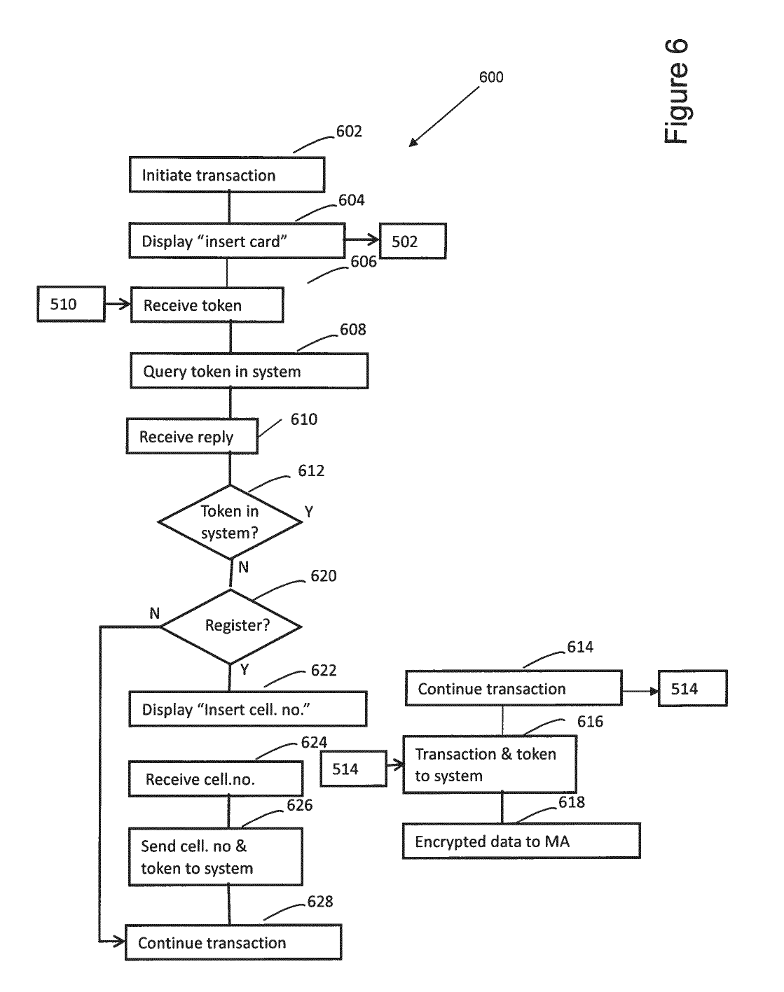

The operation of the card reader module 106a and the point of sale module 106b in accordance with an embodiment of the invention will now be described with reference to the process flow control diagrams 500 and 6000 illustrated in FIGS. 5 and 6 of the accompanying drawings. The respective sub-modules of the card reader and point-of-sale modules interact and work with each other as will now be described.

Referring now to FIG. 6, point of sale sub-module 218 provides programmatic instructions to controller 214 to initiate a transaction, step 602, by displaying on display 106c a message inviting a user to insert their payment card, step 604. Referring now to FIG. 5, process control flows to step 502 where card reader sub-module 202 provides programmatic instructions to controller 208 to detect a card input to the card reader 106a. The card reader sub-module 202 provide instructions to controller 208 to read the card details, step 504, and then encrypt the card details, step 506. As part of the encryption process, or as a separate stage, the card details are “tokenised”, step 508, responsive to instructions from the tokenisation sub-module 212. Tokenisation of the card details comprises generating a string of characters from one or more of the card details. For example, the string of characters may be generated from the cardholder account number and in general the string of characters are random or at least pseudo-random. In general, the token would be a non-reversible token because in the context of embodiments in accordance with the present invention it is not necessary to be able to reverse back to card details. Examples of how tokenisation may be used in a PCI DSS compliant environment may be found in the PCI Security Standards Council Information Supplement: PCI DSS Tokenisation Guidelines.

Controller 208 then sends the EMV token to the point of sale module 106b responsive to instructions from the tokenisation sub-module 212, at step 510. Controller 208 then waits for a request to send the encrypted card details to the point of sale module 106b, step 512. Process control then flows to step 606.

Registration sub-module 220 of the point-of-sale module 106b provides programmatic instructions for controller 214 to receive the EMV token 206 from card reader module 106a, step 606, and send a query over network interface 222 to the purchase card scheme operator server 112 concerning whether or not the token already exists in the purchase card scheme operator's system, step 608. Registration sub-module 220 provides instructions to controller 214 to wait for and receive a reply from the purchase card scheme operator's system concerning whether or not the token already exists in the system, step 610.

At step 612 controller 214 determines whether or not the reply indicates the token is in the system or not. If the token is already in the system then process flow control proceeds to step 614 where the transaction is continued. Process control flows to step 514 where encrypted card details are sent to the POS module 106b and returns to step 616 where the transaction details and token are transferred to the purchase card scheme operator's system, and then encrypted card data is transferred to the merchant acquirer 110, step 618. Process flow control then transfers to step 516 where the card reader module determines that the transaction is complete and outputs the card, step 518.

If it is determined at step 612 that the token is not already in the purchase card scheme operator's system process flow control proceeds to step 620 where controller 214 is provided with instructions from registration sub-module 220 which cause a message to be displayed on the display 106c inviting the user to register with the purchase card scheme operator's system. If the user inputs a response, typically via keypad 106d, declining the invitation process control flows to step 628 and the transaction continues as normal.

If the user response is to accept the invitation to register then process control flows to step 622 where controller 214 executes instructions from the registration sub-module 220 to cause display driver 216 to provide signals to display an invitation to insert mobile telephone number on display 106c, step 622. Controller 214 receives from keypad 106d the mobile telephone number input by user, step 624 and sends the mobile telephone number and EMV token 206 over network interface 222 to the purchase card scheme operator's server 112.

The transaction then continues, step 628, and process control then flows to step 514 where encrypted card details are sent to the POS module 106b, which in turn transmits the encrypted card details to the merchant, step 618. Process control then flows to step 516 of the card reader module operation to complete the transaction and then the card is output from the card reader 106a, step 518.

While not all of the features of the system described in general outline above with reference to FIGS. 2, 3, 4, 5 and 6 may be required, the system may be utilised to restrict the use of a credit/debit or other EMV payment card for specific purchases.

As used herein, the term ‘card file’ refers to the representation of salient data of a physical payment card in electronic form, i.e. the electronic or digital version of the parameters of the physical payment card necessary to effect payment.

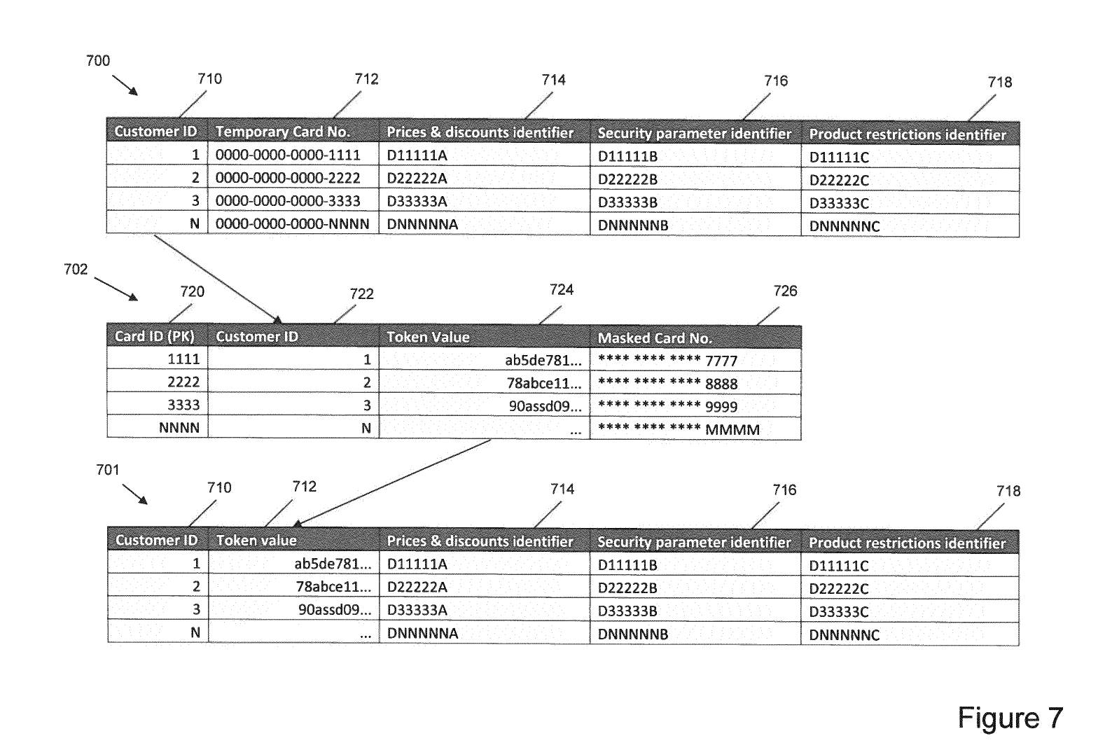

The operation of the purchase card scheme application 114, in particular the database management services of the purchase card scheme application 114 and a Merchant Acquirer 110, in particular the database management services of the Merchant Acquirer 110, concerning the creation of a restricted payment card 102 with tokenisation will now be described with reference to an example of the tables in a relational database structure in accordance with an embodiment of the present invention. Illustrated in FIG. 7 are two key tables for a database structure in accordance with the described embodiment. Each table will be referred to by its primary key. The database structure in Figure & includes a ‘Customer ID’ table 700, a ‘Card ID’ table 702 and an updated ‘Customer ID’ table 701. The relationship between the respective tables through their primary keys is illustrated by the ‘arrowed’ lines.

‘Customer ID’ table 700 comprises 5 columns. The first column, 710, is the customer ID number, the second column, 712, is the temporary card number assigned to the customer ID, the third column, 714, contains the registered prices and discounts (i.e. wholesale prices) associated with the temporary card number, the fourth column, 716, contains the security parameters associated with the temporary card number and the final column, 718, contains the purchase restrictions associated with the temporary card number. The registered prices, discounts, security parameters and purchase restrictions are examples of restriction parameters that may define a restriction specification associated with a token.

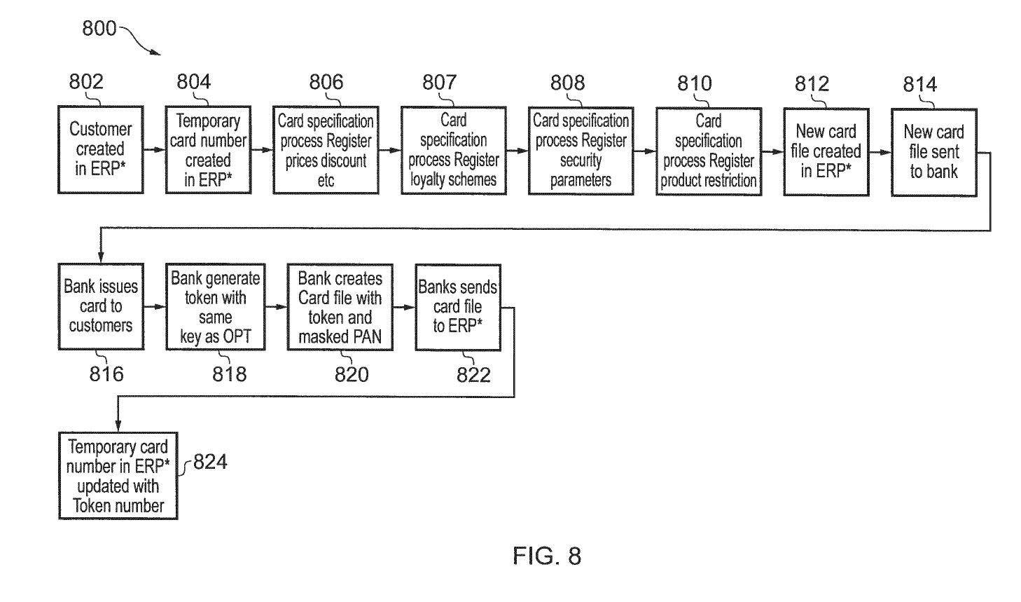

When a restricted card creation process is initiated, step 802 of the process flow control diagram 800 of FIG. 8, details of the customer for whom the card is being created are entered in the purchase card scheme application 114, for example using the ERP. At step 804 a temporary card number is created by the purchase card scheme application 114 running on the non PCI DSS compliant server 112 and assigned to a customer ID. If the customer is a new customer then a new customer ID is created. In the described embodiment, customer IDs are assigned in sequence, i.e. 1, 2, 3, . . . N, with temporary card numbers assigned sequentially as new cards are created. The purchase card scheme application 114 is then proceeds to receive prices and discounts to be associated with the temporary card number and store them in column 714 of table 700, step 806. In the described embodiment, the data stored in column 714 contains identifiers that map to price & discount tables which contain information relating to pricing or discounts associated with a particular temporary card number. At step 807, the purchase card scheme application 114 is configured to register loyalty benefits associated with the customer 120 to the temporary card number. The loyalty scheme may give benefit to a customer dependent upon the transactions made, for example loyalty points may be assigned to an account associated with the customer 120 in proportion to the value of transactions made. At step 808, the purchase card scheme application 114 is configured to assign security parameters to the temporary card number and stores the information in column 716. In the described embodiment, the data stored in column 716 contains identifiers that map to security parameter tables which may limit the use of payment card data by business identity (a particular store etc.), by geographical location (e.g. a particular city or country), by business type (e.g. petrol garage, retail store), by date (e.g. day of the week, month or a particular date), or by time of day. At step 810, the purchase card scheme application 114 is configured to assign product restrictions to the temporary card number and stores the information in column 718. In the described embodiment, the data stored in column 718 contains identifiers that map to product restriction tables which may limit the use of payment card data by merchant type (e.g. Q Star garage, Shell garage), by item/service purchase (e.g. groceries, petrol) by transaction amount, the cost of a purchase or the amount of a transfer of funds or by any other transaction characteristics.

The restrictions applied against a temporary card number define a restriction specification for that temporary card number. The process described above is the operation of the purchase card scheme application (ERP) 114 in assigning the restrictions to the temporary card number. As will be evident to the person of ordinary skill in the art, the restrictions themselves may be input by a customer defining their own restriction specification, a business defining restrictions for payment cards to be used by employees and/or the merchant acquirer/financial institution. Typically, the restrictions will be input through a suitable user interface operated from a computing device in communication with the purchase card scheme application (ERP) 114. Such restrictions may selectable from a menu or list of restrictions or definable within predefined fields such as “maximum value of transaction”.

Once the card restrictions specification process has completed a card file is created by the purchase card scheme application (ERP) 114, step 812, comprising the restrictions specification and card details such as the temporary card number and customer details. The new card file is supplied to the Merchant Acquirer 110, e.g. a bank, with a request to create a new card for the customer 120, step 814. The Merchant Acquirer 110 operates a PCI DSS compliant processing environment for the creation and management of payment card data including payment card numbers.

The Merchant Acquirer 110 processes the request and issues the new payment card to the customer 120, step 816. The Merchant Acquirer 110 “tokenises” the card details using the cryptographic key corresponding to that of the outside payment terminal (OPT), step 818. That is to say, the same cryptographic or tokenization key as is or will be used to tokenise the card details at a payment terminal is used to tokenise the card details at the Merchant Acquirer. Tokenisation of the new card data comprises generating, in the secure PCI DSS compliant environment, a string of characters from one or more of the card payment data. For example, the string of characters may be generated from the card account number and in general the string of characters are random or at least pseudo-random.

The Merchant Acquirer creates a new card file, step 820, using the token and masked primary account number (PAN) i.e. masked card number. The new card file comprises four fields, a card ID field, a customer ID field, a field for the token, i.e. token value field, and a masked card number field. The card ID is assigned sequentially as new token values are generated for new cards. The new card file is transmitted to the purchase card scheme server 112 and purchase card scheme application (ERP) 114, step 822, where it may be stored in the purchase card scheme purchase card scheme application (ERP) 114 database as a record of Bank Card ID table 702 which includes, as a primary key, the card ID stored in column 720. The token value associated with the card ID is stored in column 724. Additionally, the customer ID is stored in column 722 and is linked to the primary key of the ‘Customer’ table 700/701 thereby linking cards to customers 120. Additionally, the masked card number of the newly issued card is stored in column 726. In this way, all the relevant information is stored in the same table (table 702) creating a ‘card file with token’, in the database 701 derived from the new card files provided by the Merchant Acquirer.

At step 824, the purchase card scheme application (ERP) 114 updates the temporary card number stored in the ‘Customer’ table 700 with the token value stored in column 724 of Bank Card table 702 in the record for the card file newly added to the Bank Card table 702, step 824. For illustrative purposes the updated customer table is referenced by numeral 701 in FIG. 7 but is not a new or different table from the table illustrated and referenced as table 700, rather a representation of the customer table with the temporary card numbers replaced by tokens.

As will be evident to persons of ordinary skill in the art, other tables may be utilised and indeed the tables illustrated in FIG. 7 may be expanded upon to include more columns.

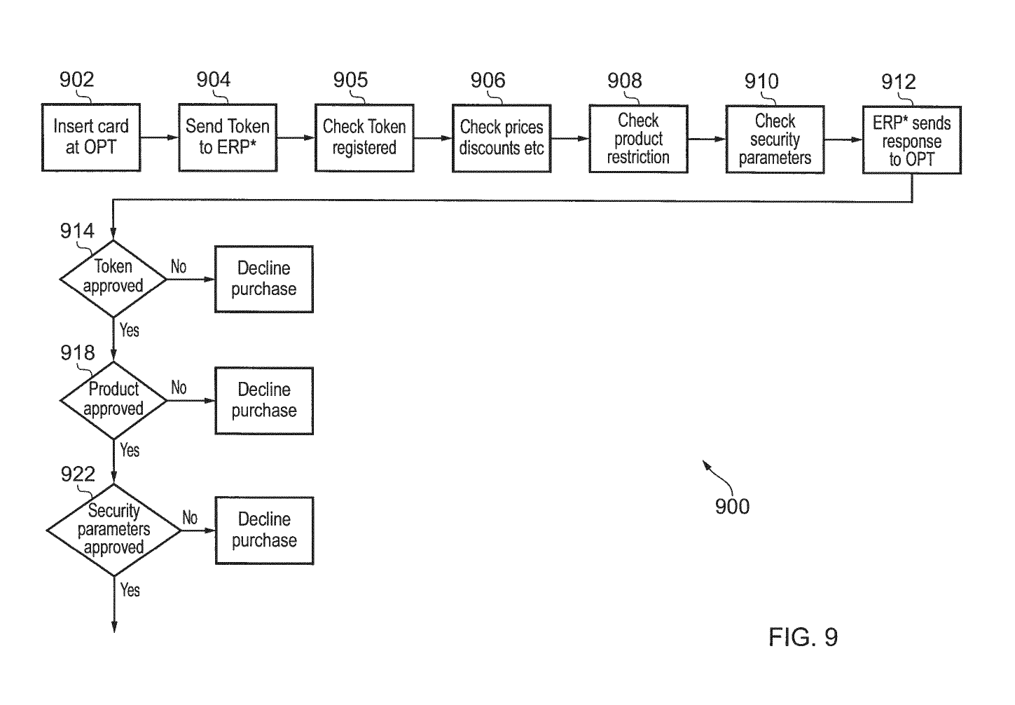

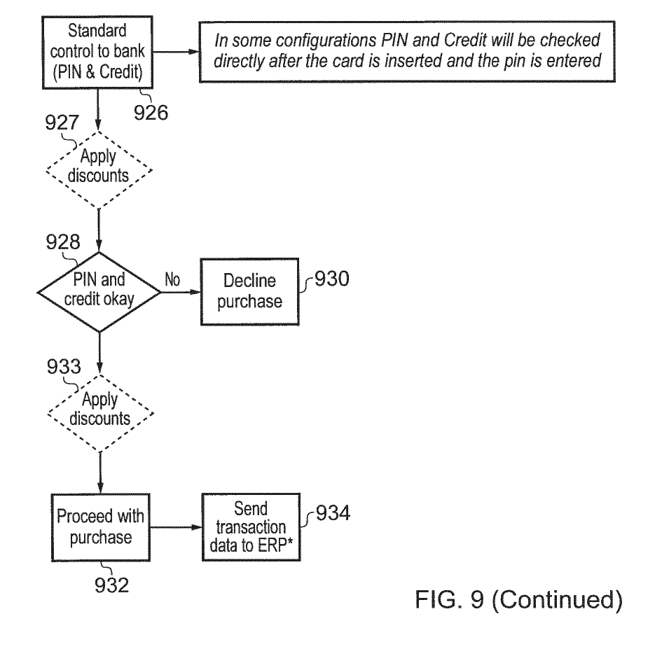

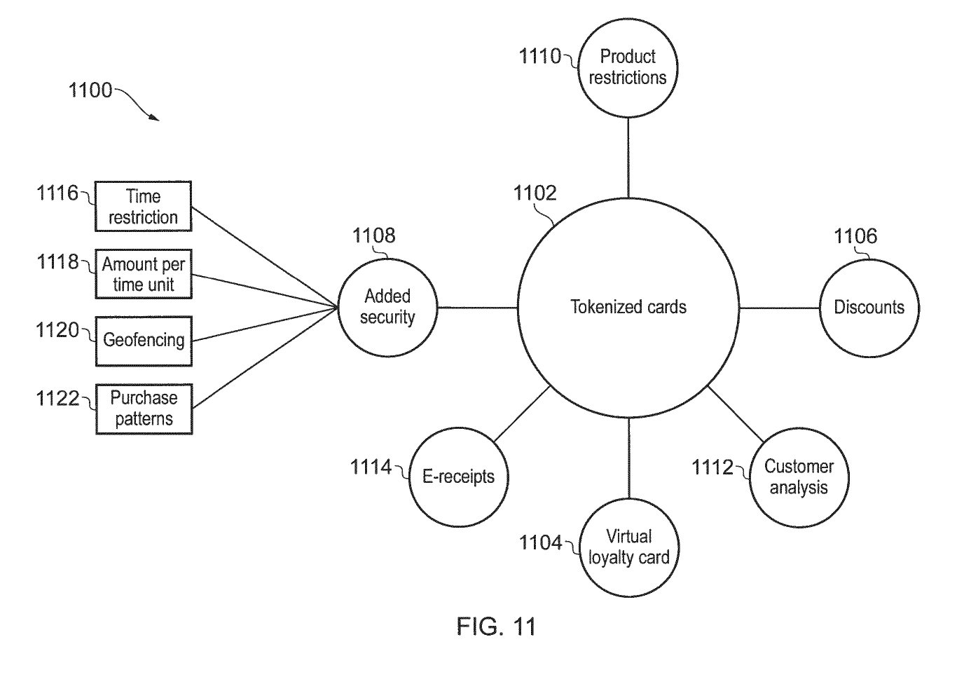

The operation of the purchase card scheme application 114, in particular the management of a token with associated purchase restrictions as illustrated in FIG. 11 and the interface with a customer will now be described in accordance with an embodiment of the present invention 900 illustrated in FIG. 9.

As will be apparent to a person of ordinary skill in the art the steps illustrated in FIG. 9 are distributed across the card reader module, registration module and purchase card operator server illustrated in FIG. 2 for example

A customer inserts an EMV payment card at a payment terminal 106, step 902, and a token 206 based on the EMV payment card details is created and transmitted to the purchase card scheme data processing application 114 on server system 112, step 904. The relevant purchase parameters 1100, such as good or service or type of good or service (product/s) 1110, identification of retailer, geographic location of retailer 1120, value of transaction etcetera are also transmitted to the purchase card scheme data processing application (ERP) 114. In the described embodiment, the tables illustrated in FIG. 7 are stored in the ERP. Identifying and forming the relevant purchase parameters into a message for transmittal to the purchase card scheme data processing application (ERP) 114 is performed by programmatic instructions invoked by the tokenisation sub-module in the payment terminal 106. may The programmatic instructions may also perform some of the functions associated with the initial stages of a purchase such as tokenisation or just be invoked where a card details indicate that it is a restricted use card. Step 904 also includes initiating verifying restrictions against a transaction. Verifying the restrictions starts with the tokenisation sub-module 212 of the payment module 106a invoking programmatic instructions for controller 214 to send a query over network interface 222 to the purchase card scheme operator server 112 to identify a set of restrictions associated with a particular token.

At step 905, the purchase card scheme data processing application 114 checks in the database stored on server 112 to determine if the token 206 has already been registered, i.e. the customer is already a user. If at step 905 it is determined that the token 206 has not yet been registered, a message is transmitted to the payment terminal to initiate a question being presented to the user interface asking whether the customer 120 would like to register the token 206 or not, and the process follows the new card registration process flow diagram illustrated in FIG. 3. If it is determined that the token 206 has already been registered, the purchase card scheme data processing application 114 process proceeds to step 906 where the price restrictions 1110 and discounts 1106 associated with the token 206 are identified and retrieved from column 714 of the relevant card record in the updated Customer table 701. Likewise, the product restrictions 1110 associated with the token 206 are identified and retrieved from column 718 at step 908; and the security parameters 1108 such as time restrictions 1116, amount per time unit parameters 1118, geofencing parameters 1120 and purchase patterns 1122 are identified and retrieved from column 716 at step 910.

In one embodiment, the purchase card scheme operator 114 queries metadata fields associated with a particular token to identify price and discounts, security parameters and product restrictions. For example, in such an arrangement, token 206 is looked up in a token value field 712 of updated Customer table 701 to identify the record comprising the relevant restrictions fields. Prices field 714 is inspected at step 906 which for the purposes of this description limits a transaction to no more than £100 but also provides a discount of 5% to a transaction. The product restriction field is inspected at step 908 where a product restriction of “diesel” is identified. At step 910, the security parameters field 716 is inspected to reveal that purchases are only permitted in the UK.

The identified restrictions associated with the token are formulated into a response message by the purchase card scheme data processing application (ERP) 114 and provided to the tokenisation sub-module at step 912.

The tokenisation sub-module can then query the transaction information with a data string representing the identified restrictions associated with the card number. The transaction is then approved or denied based on the determination as will be described.

The process continues at the payment terminal 106 where the card use restriction application continues and it is determined if the token 206 has been approved, step 914. It should be noted that in the described embodiment the check at step 914 determines whether or not the token has been approved for the products, services and other restrictions recorded against the token on the purchase card scheme data processing application (ERP) 114. The restrictions are then subsequently compared to the intended purchase. If the token 206 has not been approved the process flows to step 916 and the purchase is declined. If the token is approved at step 914, process flows to step 918 where the purchase card scheme data processing application (ERP) 114 determines whether the purchase product is approved, e.g. complies with, under the product restriction 1110 identified in the response from the purchase card scheme data processing application (ERP) 114, step 918. Any discount information provided in the response from purchase card scheme data processing application (ERP) 114, e.g. in the particular example referred to above a discount of 5%, is identified at step 118 also. If the purchase product is declined, process flows to step 920 and the purchase is declined. If the purchase product is approved, process flows to step 922, where it is determined whether the security parameters 1108 associated with the token and provided in the response from the purchase card scheme data processing application (ERP) 114 are satisfied. If the security parameters are not satisfied, process flows to step 924 and the purchase is declined. If the security parameters 1108 are satisfied, process flows to step 926 and the transaction is approved.

Responsive to a determination that the restrictions are satisfied, the token 206 is transmitted to the merchant acquirer. The merchant acquirer performs the appropriate look up within their secure PCI DSS compliant server environment to produce the payment information associated with the selected token, step 926. In some embodiments, prior to processing the transaction, the merchant acquirer 110 can seek authorisation for the transaction from the customer. Accordingly, the merchant acquirer 110 can send an authorisation request including, for example a request that a PIN or password be entered by the customer at the payment terminal 106 before the transaction can be authorised, step 928. The discount information identified at step 918 will be applied to the transaction at an appropriate stage depending upon whether the payment terminal is manned or unmanned. For a manned payment terminal, the discount is applied to the price displayed at the payment terminal prior to a customer proceeding with or authorising the transaction, i.e. at step 927. Optionally, if the payment terminal is unmanned the discount is applied when the transaction is complete and the value of the original transaction is known and payment is due, i.e. at step 933.

Beneficially, the payment information itself is not stored at the purchase card scheme operator server 112, limiting the exposure and risk of conducting transactions. In addition, by associating one or more restrictions with a token, checks can be applied based on the token and the customer further limits the risk of an unauthorised entity conducting transactions with the credit or debit cards in the event they are lost or stolen. An unauthorised entity that gains access to the credit or debit cards will be restricted in the use of the payment card based on the restrictions selected by the customer. By utilizing a token to apply use restrictions, the use restrictions may be managed and applied outside of a PCI DSS compliant environment and managed by a third party other than the financial institution/merchant acquirer issuing the payment card.

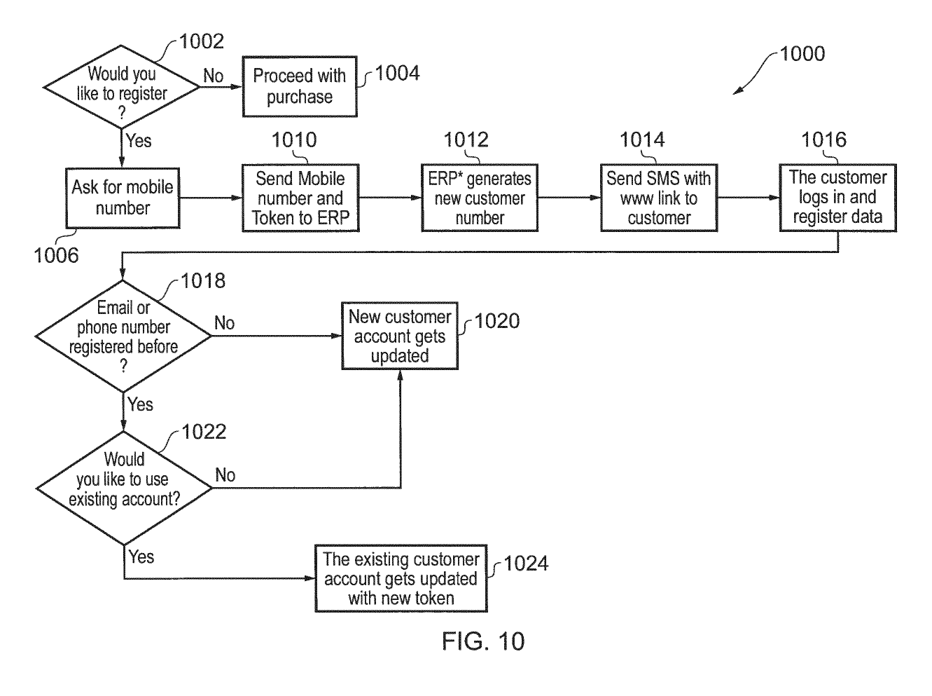

One or more embodiments may be configured to permit an existing user to register further or existing cards to the system. An example of the operation of such an embodiment will now be described with reference to the process flow control diagram 1000 illustrated in FIG. 10 of the accompanying drawings.

As will be apparent to a person of ordinary skill in the art the steps illustrated in FIG. 10 are distributed across the card reader module, registration module and purchase card operator server illustrated in FIG. 2 for example. At an appropriate point in a transaction process 1000, for example after a card has been inserted into the card reader, the card details are tokenised and the purchase card operator's system is interrogated for the token and if no corresponding token is found, a message is displayed asking the user if they would like to register the card inserted in the card reader, step 1002. If the user responds “No”, for example pressing a designated key on a keypad or a “soft key” on a touch sensitive display, the system proceeds with the transaction procedure, step 1004. If the user responds with a “Yes” then process control flows to step 1006 where a message is displayed requesting the user's mobile telephone number.

The mobile telephone number input at step 1006 is transmitted to the purchase card scheme operator server 112 together with what imay be termed a “new” token, step 1010, and the purchase card operator application 114 generates a new user (customer) ID number, step 1012. An SMS message comprising a URL link is transmitted to the user's (customer's) mobile telephone at step 1014.

The user/customer may activate the URL link, if it is a hot link, which automatically launches a web browser session or inputs it into a web browser to access the web page for the purchase card operator application that provides an interface for a user/customer to input their personal data for association with the new token uploaded to the application. The purchase card operator application then searches its database for one or more elements of the user/customer details just input, for example an email or telephone number, step 1018. If no corresponding detail or details can be found a new user/customer account is created, step 1020.

If one or more of the details are found in the purchase card operator's database then a message is displayed through the web browser asking the user/customer if they would like to use the existing account, step 1022. If the user/customer answers “No” process control flows to step 1020 and a new account is created for the recently uploaded token representing the new card and process flows to the card specification process, step 806 and product and security restrictions may be associated with the new card. Otherwise, process control flows to step 1024 where the existing customer account having the corresponding details is updated with the new token and process flows to the card specification process, step 806 and product and security restrictions may be associated with the new card. In the described embodiment, the existing customer account may be updated by inserting their existing user identity into the relevant table.

Thus, a user/customer may link further cards to their account.

In summary and general outline, the processing of EMV data requires a PCI DSS environment to ensure that sensitive information are not compromised when making a transaction. Such security controls require a high security IT and physical environment to operate in, which by its very nature means higher costs are placed on this type of data handling. Tokenisation is a process by which the whole transaction is decoupled from the sensitive EMV data and replaced by a special and unique token number enabling secure data to be anomalous, allowing easier processing and reduced costs. It also allow for other benefits, such as data analytics and manipulation for various added value services such as purchase restrictions and security parameters associated with a token.

The Applicant has developed a novel method of generating tokens based on restrictions. In addition, tokenisation has provided new data fields to provide richer information about the transaction, which can help improve fraud detection and expedite the approval process. Furthermore, the method utilises a common standard design to simplify the process for merchants for contactless, online or other transactions.

Insofar as embodiments of the invention described above are implementable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems in whatever format they may arise, for example, desktop personal computer, laptop personal computer, tablet, smart phone or other computing device.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD) subscriber identity module, tape, cassette solid-state memory. The computer program may be supplied from a remote source embodied in the communications medium such as an electronic signal, radio frequency carrier wave or optical carrier waves. Such carrier media are also envisaged as aspects of the present invention.

As used herein any reference to “one embodiment” or “an embodiment” means that a particular element, feature, structure, or characteristic described in connection with the embodiment is included in at least one embodiment. The appearances of the phrase “in one embodiment” or the phrase “in an embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention. For example, although an embodiment of the invention has been described with reference to a payment terminal 106 having a single controller implementing separate card reader module 106a and point-of-sale module 106b with respective controllers and display drivers 208/210 and 214/216 it will be evident to a person of ordinary skill in the art that the separate modules, controllers and display drivers may be combined into a single module, controller and display driver. Indeed, the display driver need not be a separate module from the controller.

Additionally, the functions of the tokenisation sub-module 212 and registration sub-module 220 may be integrated with one or more controllers. Furthermore, although tokenisation is generally considered to comprise a non-predictable, one-way, irreversible function to generate a string of characters from initial data which generally excludes encryption because encryption involves use of a key for decryption it will be evident to a person of ordinary skill in the art that encryption techniques could be used in the tokenisation process and indeed a reversible encryption algorithm could be utilised to generate a token which could be used in one or more embodiments of the present invention. Consequently, the term “tokenisation” and related and derived terms are not limited to embodiments in which the token character string is generated in irreversible random or pseudorandom way but may include a token character string been generated using an encryption algorithm.

The terms “customer” and “user” may refer to the same person where a purchaser of a good or service is also a user of the purchase card system. Optionally, the term “customer” may refer to a purchaser of a good or service not a user, or not yet a user, of the purchase card system. Likewise, the term “user” may be used to refer to a person who is a member of the purchase card system when they are making a purchase using an EMV card and not a purchase card scheme card. Consequently, the terms “customer” and “user” may be used interchangeably or to refer to different categories of person depending upon the context as appropriate. The terms “customer” and “user” are not intended to unduly limit the scope of the disclosure or appended claims and they should be construed in accordance with the context in which they are used.

Although embodiments of the invention have been described with reference to mobile telephone numbers being input to a POS other or additional suitable contact details may be used such as an email address. Additionally, the terms “card details” and “card data” are used interchangeably and are intended to refer to the same thing unless the context requires otherwise.

The completion of registration details by inputting personal data may be performed immediately following the transaction initiating registration, for example through a web browser provided on a smart phone. However, it is likely to be done at a later time at the user's convenience.

At step 318 in the process flow control diagram for the registration of a user of the described embodiment it is determined if it is time for a reminder to the customer to register as a user, optionally however no determination of a time for a reminder may be made. Instead, the process may merely offer an unregistered customer the option of registering if they are not already registered each time the customer uses their purchase card.

Although one or more embodiments have been described with reference to registered prices, discounts, security parameters and purchase restrictions such are only examples of restriction parameters that may define a restriction specification associated with a token. Other restrictions and parameters may be utilized additionally or optionally to define a restriction specification.

The process for creating a restricted card refers to initially creating a “temporary card number”. The term “temporary card number” is conceptually simple to understand in the context of payment card creation but the person of ordinary skill in the art will recognize that the temporary card number is a label or identifier against which a restriction specification may be applied pending creation of a new payment card and assigning the restriction specification to the token generated from the new payment card number or assigning the restriction specification to a token generated from an existing payment card number. Any suitable label may be used as a temporary identifier. Additionally, the described embodiments send the temporary card number to the merchant acquirer/financial institution issuing the EMV card. However, the request for a new restricted use payment card or to apply restrictions again an existing payment card need not include the temporary card number and the temporary card number need not be utilised by the merchant acquirer/financial institution in the generation of the new restricted use payment card or in the tokenisation process for use in applying restrictions to an existing payment card. All that is necessary is that the response to the request may be matched to the label so that the token may replace the label.

The described embodiments utilise the same tokenization key as is used in payment terminals. However, the tokenization key need not be the same as used for tokenisng the card details for other purposes. That is to say different tokens may be created from a payment card details for different purposes.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

1-37. (canceled)

38. A method of creating a restricted use payment card, the method comprising:
generating, in a data processing environment non-compliant with a security requirement for payment cards, a label;
storing the label in the non-compliant data processing environment; and
providing to a data processing environment compliant with the security requirement a request to create a new payment card;
generating in the compliant data processing environment:
new payment card data; and
a token from the new payment card data;
providing the token to the non-compliant data processing environment; and
replacing the stored label with the token value;
optionally wherein the label comprises a temporary card number; and
optionally wherein the terminal is a payment card terminal compliant with a security requirement for payment cards.

39. The method of claim 38, further comprising providing the label to the compliant data processing environment with the request to create a new payment card; optionally further comprising storing the label in association with a customer identifier.

40. The method of claim 38, further comprising, in the non-compliant data processing environment, storing in association with the label a restriction specification defining a use restriction for the new payment card.

41. The method of claim 40, further comprising providing an interface to the non-compliant data processing environment configured to permit creation of the restriction specification.

42. The method of claim 40, further comprising storing the restriction specification and token in respective fields of a customer restricted use card record.

43. The method of claim 42, further comprising configuring the customer restricted use card record to provide sub-fields for the restriction specification for storing a respective type of restriction.

44. A method of creating a restricted use payment card, the method comprising:
generating in a first data processing environment compliant with a security requirement for payment cards a token from a payment card data;
associating with the token a restriction specification defining a use restriction for the payment card; and
storing the token and restriction specification.

45. The method of claim 44, further comprising providing the token and restriction specification to a second data processing environment non-compliant with the security requirement for payment cards.

46. A method of applying a use restriction to a payment card, the method comprising:
at a terminal compliant with a security requirement for payment cards generating a token from a payment card data input to the terminal and transmitting the token to a data processing environment non-compliant with a security requirement for payment cards;
at the non-compliant data processing environment:
receiving the token identifying one or more use restrictions associated with the token;
providing a response to the terminal comprising the one or more use restrictions associated with the token;
at the terminal:
receiving the one or more use restrictions associated with the token;
determining whether a purchase submitted to the terminal satisfies the one or more use restrictions; and
initiating fulfilment of the purchase submitted to the terminal satisfying the one or more use restrictions.

47. The method of claim 46, wherein initiating fulfilment of the purchase comprises transmitting transaction details for the purchase to a merchant acquirer for the payment card.

48. The method of claim 47, wherein a one of the one or more use restrictions comprises a discount value for applying to a transaction, the method further comprising applying the discount to the value of the purchase prior to initiating fulfilment of the purchase; optionally wherein a one of the one or more use restrictions comprises a discount value for further comprising applying the discount to the value during fulfilment of the purchase.

49. The method of claim 46, further comprising inhibiting a transaction with the payment card for a purchase submitted to the compliant card payment terminal not satisfying the one or more use restrictions.

50. A system for creating a restricted use payment card comprising a data processing environment non-compliant with a security requirement for payment cards and a data processing environment compliant with a security requirement for payment cards;
the non-compliant data processing environment configured to:
generate a label;
store the label in the non-compliant data processing environment; and
provide to the compliant data processing environment a request to create a new payment card;
the compliant data processing environment configured to:
generate new payment card data;
generate a token from the new payment card data; and
provide the token to the non-compliant data processing environment;
the non-compliant data processing environment further configured to replace the stored label with the token value.

51. The system of claim 50, further configured to provide the label to the compliant data processing environment with the request to create a new payment card.

52. The system of claim 50, wherein the non-compliant data processing environment is further configured to store in association with the label a restriction specification defining a use restriction for the new payment card; optionally further configured to store the label in association with a customer identifier.

53. The system of claim 51, further configured to provide an interface to the non-compliant data processing environment configured to permit creation of the restriction specification.

54. The system of claim 52, further configured to store the restriction specification and token in respective fields of a customer restricted use card record.

55. The system of claim 54, further configured to arrange the customer restricted use card record to provide sub-fields for the restriction specification for storing a respective type of restriction.

56. The system of claim 50, wherein the label comprises a temporary card number.

57. An apparatus for creating a restricted use payment card, configured to:
comply with a security requirement for payment cards;
generate a token from a payment card data;
associate with the token a restriction specification defining a use restriction for the payment card; and
store the token and restriction specification.

58. The apparatus of claim 57, further configured to provide the token and restriction specification to a data processing environment non-compliant with the security requirement for payment cards.

59. A system for applying a use restriction to a payment card, comprising a terminal compliant with a security requirement for payment cards and a data processing environment non-compliant with a security requirement for payment cards;
the terminal configured to:
generate a token from a payment card data input to the terminal; and
transmit the token to the non-compliant data processing environment;
the non-compliant data processing environment configured to:
receive the token identifying one or more use restrictions associated with the token;
provide a response to the terminal comprising the one or more use restrictions associated with the token;
the terminal further configured to:
receive the one or more use restrictions associated with the token;
determine whether a purchase submitted to the terminal satisfies the one or more use restrictions; and
initiate fulfilment of the purchase submitted to the terminal satisfying the one or more use restrictions.

60. The system of claim 59, further configured to initiate fulfilment of the purchase by transmitting transaction details for the purchase to a merchant acquirer for the payment card.

61. The system of claim 60, wherein a one of the one or more use restrictions comprises a discount value for applying to a transaction, the system further configured to apply the discount to the value of the purchase prior to initiating fulfilment of the purchase; optionally wherein a one of the one or more use restrictions comprises a discount value for applying to a transaction, the system further configured to apply the discount to the value during fulfilment of the purchase.

62. The system of claim 59, further configured to inhibit a transaction with the payment card for a purchase submitted to the terminal not satisfying the one or more use restrictions; optionally wherein the terminal is a payment card terminal compliant with a security requirement for payment cards.
